(19) United States
(12) Patent Application Publication
(10) Pub. No.: US 2012/0037008 A1
(43) Pub. Date: Feb. 16, 2012

(54) Programmable multiple ingredient dispensing coffee maker with customizable settings for multiple individual preferences

(76) Inventor: Nelson Antonio Rodriguez, Winter Park, FL (US)

(21) Appl. No.: 12/791,939

(22) Filed: Aug. 16, 2010

(51) Int. Cl. A47J 31/44

(52) U.S. Cl. 99/289 R

(57) ABSTRACT

Provided is a grab and go themed coffee maker that stores and dispenses multiple ingredients into a cup or container with specific amounts of each ingredient according to the individual's beverage preferences and the desired time of day they want the beverage. It can be programmed for multiple users. This invention will accommodate multiple users with their desired hot beverage, their desired ingredients and their desired ingredient quantities at their desired brew time. It contains an LED screen with LED buttons as a user interface. In the interior it has multiple chambers with sensors inside each for storage of ingredients and each has dispensing mechanisms. The exterior tray where the cup or container for beverage is located also has an LED sensor. It also contains a microchip for use as an internal memory to store user interface settings and individual beverage preferences.

Patents on how to brew coffee already exist and patents on the many processes on how to do it exist. I am not inventing a new brew process. My idea focuses on the ability to offer the end user multiple ingredients, with customizable settings; like individual brew times and ingredients amounts

I have researched many patents online and found none to offer a household coffee maker with the intent offered by this invention. I have also looked at coffee maker manuals online and found none that currently offer a household coffee maker with these intentions.

The concept of this invention is the ability to store and dispense multiple ingredients into a cup or container with specific amounts of each ingredient according to each individual's preferences. Each individual utilizing the machine will be able to program their specific brew time and program the specific amount of their preferred ingredients.

The problem many people have in the morning is; they wake up and are in a hurry to prepare everything they need to leave the home. Coffee is usually prepared and brewed at this time and it is among the many things someone preps and brews in a morning routine. My concept will eliminate the preparation process of coffee and a person can have more time to do other things before they leave the home. My invention will essentially provide multiple individuals with their own specific cup of coffee at their desired time of day with no preparation by the individual needed. Just wake up and remove the cup of coffee from the machine with all the preferred ingredients already in it. When there are multiple household members there are naturally multiple coffee preferences. This invention will accommodate all members of a home with their desired cup of coffee and ingredients at their desired brew time, allowing for a simpler and more convenient lifestyle.

It will also be cost effective for a household. Many people go out of their way to get a specific cup of coffee with specific ingredients at a high cost. This will allow people to have their desired coffee at a significantly reduced cost to them. Lots of people get up earlier than usual before work so that they have time to go out of their way to stop by their favorite coffee shop to pick up their favorite coffee. This invention will let them have their favorite cup of coffee waiting for them as soon as they wake up.

Many people would love to have their favorite cup of coffee ready and waiting for them as soon as they wake up with all of their preferred ingredients already in it. All they would need to do is pick up their cup, stir and drink. This invention is simple, convenient and cost effective.

The concept of this invention will accommodate all households. It will satisfy the needs of all individuals and save the user time and money.

### DESCRIPTION OF HOW IT IS MADE

This machine contains no new matter.

External: I have no interest in how the exterior of the machine will look like.

Internal:

It is comprised of multiple airtight compartments with seals for each and having a sensor to monitor the quantity of the ingredient and alert the user when the ingredient is low.

It will have a water reservoir compartment, to store water and a heating element, which will be located towards the rear of the housing.

There is one compartment, marked with an icon of a coffee bean, which is used to store ground coffee.

There are multiple compartments to separately store the desired ingredients the user wants automatically added to the each individual beverage. Examples can be, but are not limited to; sugar, creamer and/or French vanilla flavoring, among others so long as the ingredient is powdered or granular. Each of these compartments will be removable for cleaning and it is optional for the user to use all or none of the compartments. Each compartment will be airtight and made of lightweight plastic material that maintains freshness of ingredients and prevents coagulation so that an even flow is maintained throughout the entire brewing process. Attached to each is a dispensing unit with tubing to carry dispensed ingredients to the cup from compartments. A motor circuit board panel is used to control the mechanism that dispenses the ingredients

The programmable multiple ingredient dispensing coffee maker with customizable settings for multiple individual preferences will incorporate a reusable filter made of non corrosive material which is divided into multiple sections for storing fresh ground coffee. The filter will rotate and the desired amount of ground coffee for each individuals programmed brew cycle will be automatically dispensed into an empty section. After all programmed brew cycles are completed, the filter must be removed for dispensing of the used ground coffee and for cleaning and drying. A sensor will alert the user when the filter needs to be removed for cleaning.

It will also include a circuit board containing a clock display, icon LED's, and microcontroller to store and execute commands entered by each individual user. The same circuit will maintain time of day and user settings between power cycles. There will also be multiple small motors that will be wired to the circuit board and microcontroller to assist in the rotation of the filter and for controlling the dispensing of exact portions of the coffee and additional desired ingredients into the cup or appropriate container.

The dispensing unit for each compartment will be a device at the opening at the base of the compartment that is controlled by a motor that dispenses specific amounts of the ingredients from the compartment to the cup or container according to the data the multiple individual users entered.

The programmable multiple ingredient dispensing coffee maker with customizable settings for multiple individual preferences and LED screen uses a microcontroller with permanent memory. It has the capacity to control all aspects of the invention; the clock features, the LED display, running all the motors and monitoring the multiple individuals input.

The power cord is attached to an internal fused power supply, used to power the circuit board and all of its peripherals.

### How to Set Up and Operate the Machine

First time use. Remove from box and clean all removable parts. Fill water reservoir with water and run once to clean pathways of ingredients. Each compartment contains a removable dispensing mechanism for cleaning.

Open the lid to the top of the machine. Fill each compartment with the proper ingredients. The water reservoir must be filled.

One of the compartments is already marked for storing the ground coffee. The rest of the compartments can be filled with the preferred ingredients of the user.

After filling the compartments, plug the machine in. At this point adjust the clock to display the current time. Once the current time is saved it is possible to store multiple coffee cup preferences and brew times. The menu allows the multiple users to choose from variety of options to store in the internal memory; assigning users, storing each user's preferences of ingredients and quantity for their beverage and desired individual brew times for each.

Once the coffee maker has completed all stored brew cycles, the coffee filter must be removed for cleaning and re-inserted into the machine. An LED indicator will let the user know when the filter needs to be removed for cleaning. Open the drawer storing the filter of the machine and slide out the filter, dispose of the used coffee ground and rinse the filter. Dry the filter with a dry cloth or paper towel and reinsert the filter. Now the machine is ready to brew again. The multiple users are directed to replenish ingredients as needed by sensors in each compartment.

### BRIEF DESCRIPTION OF DRAWINGS

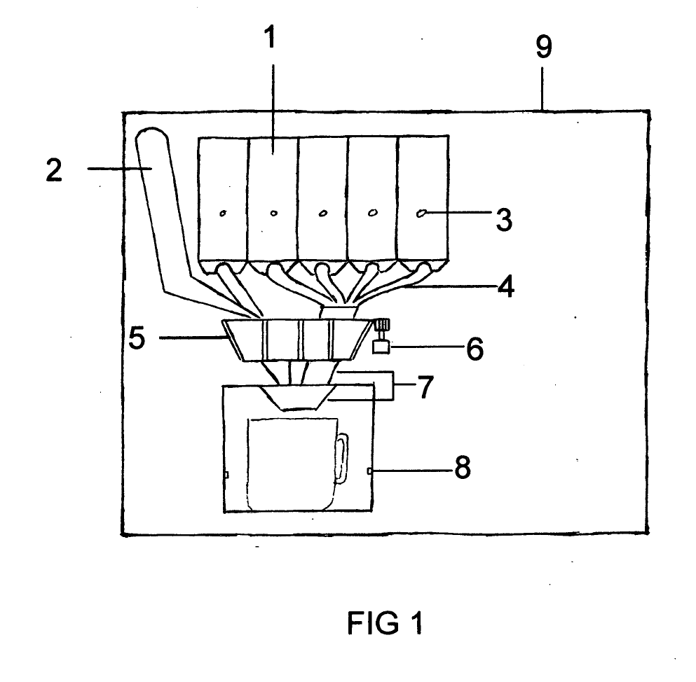

FIG. 1: This is a drawing of the front view of the interior of the machine
1. Ingredient Compartment
2. Water Funnel
3. LED Sensor for Ingredient Quantity
4. Tubing for Ingredient Transfer
5. Filter
6. Motor for Rotating Filter
7. Funnels for dropping Ingredients into container
8. LED Sensor for Container Presence
9. Outer Frame of machine

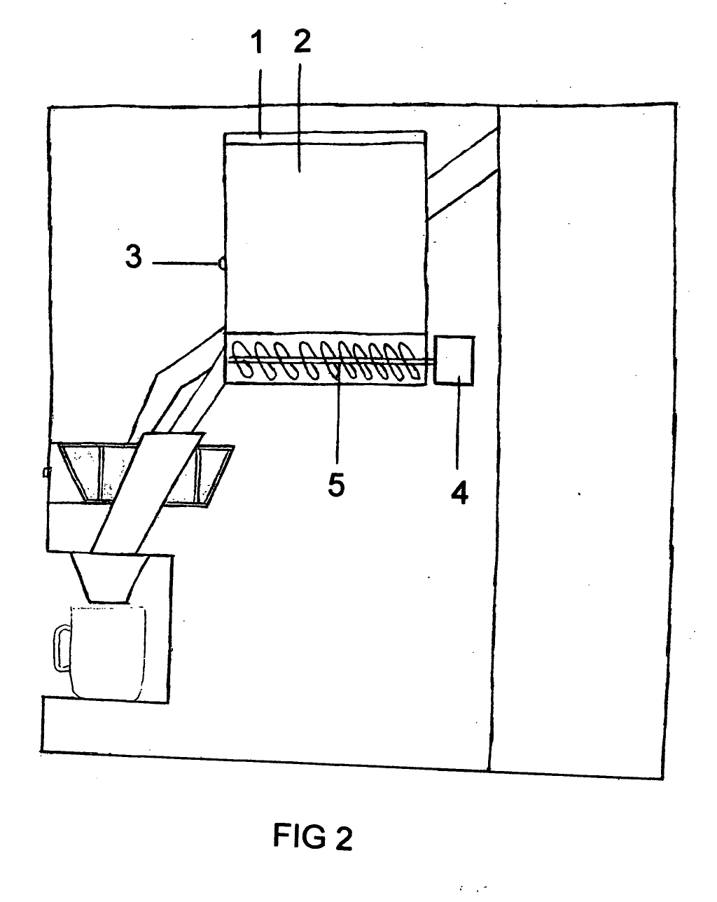

FIG. 2: This is a drawing of the side view of the interior of the machine
1. Sealed Compartment Lid
2. Ingredient Compartment
3. LED Sensor for Quantity of Ingredient in Compartment
4. Motor
5. Rod with Angled Discs to push out ingredients

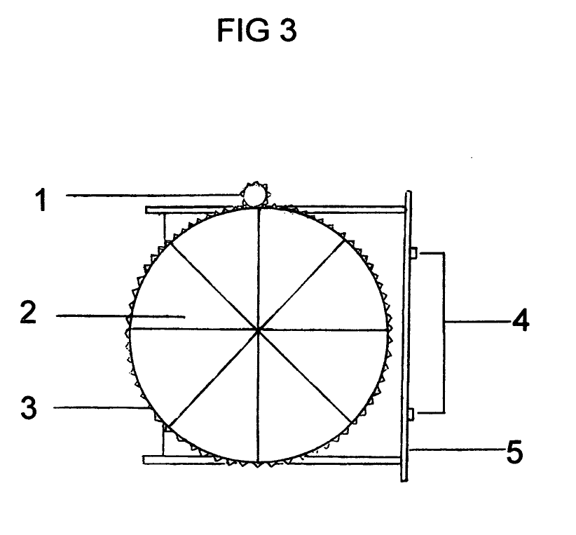

FIG. 3: This is a drawing of the top view of the filter
1. Motor for rotating filter
2. Filter compartment spaces
3. Filter
4. Knobs for removing filter from machine
5. Filter tray

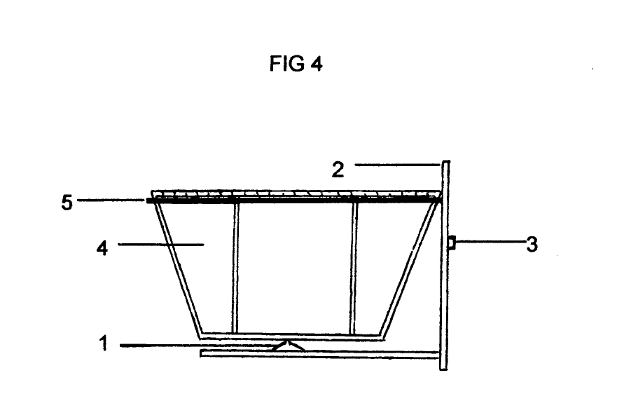

FIG. 4: This is a drawing of the side view of the filter
1. Filter Stand
2. Filter Tray
3. Knob for holding Filter
4. Filter
5. Arm for holding filter

1. My claim is a programmable multiple ingredient dispensing coffee maker with customizable settings for multiple individual preferences.
My objective is to patent this idea and license it to prospective companies.
